(19) United States
(12) Patent Application Publication
(10) Pub. No.: US 2022/0396085 A1
(43) Pub. Date: Dec. 15, 2022

(54) CONDENSATION CONTROL IN AN INKJET PRINTER

(71) Applicant: Hewlett-Packard Development Company, L.P., Spring, TX (US)

(72) Inventors: Nicholas James Meisner, Corvallis, OR (US); Joseph Martin Santich, Corvallis, OR (US); Alon Levin, Netanya (IL)

(73) Assignee: Hewlett-Packard Development Company, L.P., Spring, TX (US)

(21) Appl. No.: 17/775,024

(22) PCT Filed: Nov. 21, 2019
(86) PCT No.: PCT/US2019/062627

§ 371 Date: May 6, 2022

(51) Int. Cl. B41J 29/377

(52) U.S. Cl. CPC B41J 29/377

(57) ABSTRACT

In one example, a process to control condensation in an inkjet web printer includes injecting hot, dry air into the print zone. In another example, a shroud assembly includes a shroud spanning a full width of the print zone and having openings therein through which printheads are exposed during printing and an air injector attached to or integral with the shroud. The air injector spans a full width of the print zone upstream from all of the openings in the shroud. The air injector is configured to discharge air down and downstream with respect to a print media moving through the print zone during printing.

### BACKGROUND

During high speed thermal inkjet printing water vapor in the air in the print zone may condense on nearby surfaces.

### DRAWINGS

FIG. 1 illustrates one example of a condensation control system for an inkjet printer.

FIG. 2 illustrates an inkjet web printer implementing one example of an air injector for a condensation control system such as that shown in FIG. 1.

FIGS. 3 and 4 are more detailed views illustrating one example of an air injector for the printer shown in FIG. 2.

FIG. 5 illustrates example flow regimes for injecting hot, dry air into a print zone using an air injector such as the air injector shown in FIG. 4.

FIG. 6 illustrates one example of a print bar for an inkjet web printer.

FIG. 7 illustrates one example of a shroud assembly for a print bar such as the print bar shown in FIG. 6.

FIGS. 8-10 are more detailed views illustrating the air injector in the shroud assembly shown in FIG. 7.

FIG. 11 illustrates example processes to control condensation in an inkjet printer.

The same part numbers refer to the same or similar parts throughout the figures. The figures are not necessarily to scale.

### DESCRIPTION

In high speed thermal inkjet printing, print defects caused by the condensation of water on the exposed surfaces of printheads and other structures in the print zone may limit printing speed, ink density and the type of print media. The occurrence of defect-causing condensation increases with faster printing speeds, higher printhead nozzle densities, and a wider range of print media weights and coatings. A new technique has been developed to help reduce condensation by lowering the dew point in the print zone below the temperature of nearby surfaces on printheads and other structures. Hot dry air is injected into the print zone under conditions sufficient to lower the dew point in the print zone to reduce condensation but without disturbing ink drops jetted on to the print media. For example, testing shows that 40° C. to 55° C. air with a relative humidity of 5% or less injected into the print zone at a 45° angle down toward the print media at 50 m/s significantly reduces condensation without disturbing ink drops jetted on to the moving media.

Examples of the new technique may be implemented in a shroud assembly that includes a shroud with openings for the printheads and an air injector attached to or integral with the shroud immediately upstream from the printhead openings. The air injector has a plenum and an outlet from the plenum through which pressurized air in the plenum is discharged at the desired speed across the full width of the print zone. The outlet is oriented to discharge the hot dry air down and downstream into the print zone at the desired angle.

These and other examples described below and shown in the figures illustrate but do not limit the scope of the patent, which is defined in the Claims following this Description.

As used in this document: “dry” air means air with a relative humidity 5% or lower; “hot” air means air with a temperature 40° C. or higher; a “memory” means any non-transitory tangible medium that can embody, contain, store, or maintain instructions for use by a processor and may include, for example, circuits, integrated circuits, ASICs (application specific integrated circuits), hard drives, random access memory (RAM), read-only memory (ROM), and memory cards and sticks and other portable storage devices; and a “printhead” means an inkjet type dispenser for a 2D or 3D printer to dispense ink or other liquids, for example as drops or streams.

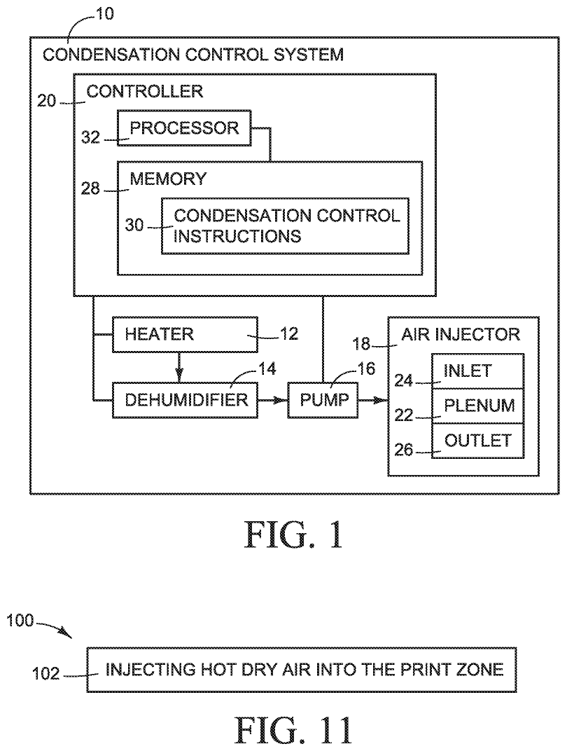

FIG. 1 illustrates one example of a condensation control system 10 for an inkjet printer. Referring to FIG. 1, condensation control system 10 includes a heater 12, a dehumidifier 14, an air pump 16, an air injector 18 and a controller 20. Air injector 18 includes a plenum 22, an inlet 24 through which air is pumped into plenum 22, and an outlet 26 through which air is discharged from plenum 22. In this example, controller 20 is operatively connected to heater 12, dehumidifier 14, and pump 16 and configured to control each component to maintain the desired temperature and humidity of air pumped into plenum 22, and to maintain the desired air pressure within plenum 22. System 10 may also include temperature, humidity and pressure sensors (not shown) to help controller 20 maintain the desired operating conditions for system 10.

Controller 20 represents the programming, processors and associated memory, and the electronic circuitry and components needed to control the operative elements of system 10. In particular, in this example controller 20 includes a memory 28 with condensation control instructions 30 and a processor 32 to read and execute instructions 30. Although controller 20 is shown separate from heater 12, dehumidifier 14, and pump 16 in FIG. 1, controller 20 may include distinct control elements for individual system components 12, 14, and 16. For example, heater 12, dehumidifier 14, and pump 16 may each include an application specific integrated circuit (ASIC) or other microcontroller programmed with a respective part of instructions 30 to achieve the desired temperature, humidity and pressure of air in plenum 22. Other suitable configurations for controller 20 are possible.

Air pump 16 may be implemented, for example, as an air compressor located upstream from air injector 18 in the direction air flows to plenum 22 to push hot, dry air into plenum 22. Heater 12 may be implemented, for example, as an inline process air heater with an electric heating element. Dehumidifier 14 may be implemented, for example, as a water trap in a compressed air system used to pressurize plenum 22. It may be desirable in some implementations to heat the ambient air, which lowers relative humidity, and then dehumidify the heated air. Thus, in the example shown in FIG. 1, heater 12 is located upstream from dehumidifier 14 in the direction air flows to plenum 22. In printing environments with warmer, drier ambient air, the desired relative humidity for the injector air may be achieved using just a water trap (or multiple water traps) in a compressed air system (including a pump 16) downstream from heater 12. An active dehumidifier may be desirable for other printing environments.

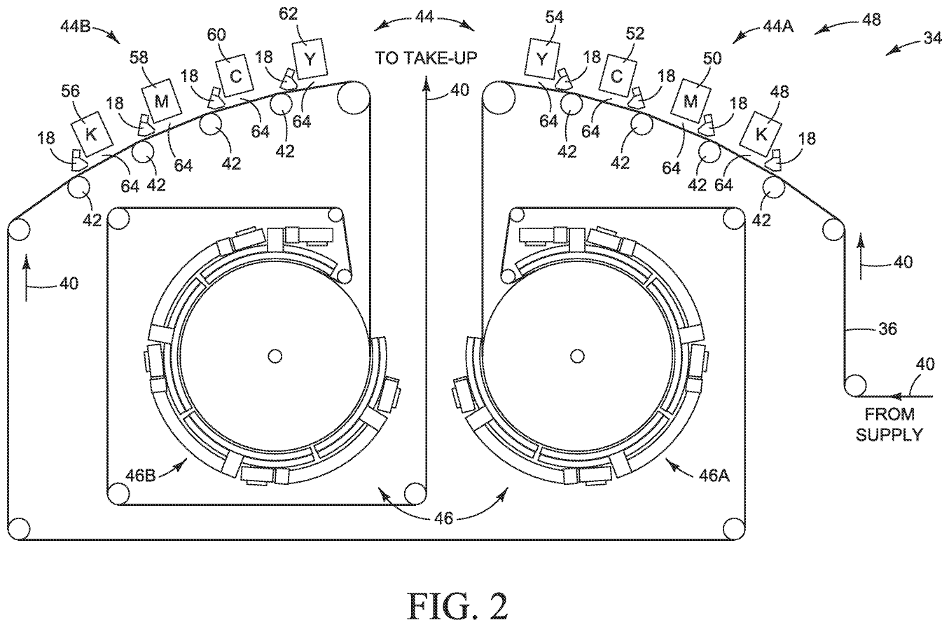

FIG. 2 illustrates a 2D inkjet web printer 34 implementing one example of an air injector 18 for a condensation control system such as system 10 shown in FIG. 1. Referring to FIG. 2, printer 34 includes a web supply (not shown) from which a print media web 36 is fed to a printing station 38 and a web take-up (not shown) to which web 36 is taken after passing through printing station 38. Arrows 40 indicate the direction web 36 moves through printing station 38 over tensioning rollers 42.

Printing station 38 includes an arched printing unit 44 and a dryer 46 under arched printing unit 44. In this example, arched printing unit 44 includes a first printing unit 44A for printing on one side of web 36 and a second printing unit 44B for printing on the other side of web 36. First printing unit 44A includes a first series of printheads 48, 50, 52, and 54 arranged along an arc on one side of arched printing unit 44. Second printing unit 44B includes a second series of printheads 56, 58, 60, and 62 arranged along an arc on the other side of arched printing unit 44. Each printhead 48-62 represents one or multiple printheads that together define a corresponding print zone 64 spanning substantially the full width of print media web 36. In one example, printheads 48-54 and 56-62 dispense black (K) ink, magenta (M) ink, cyan (C) ink, and yellow (Y) ink, respectively, on to print media 36 as it moves through each print zone 64.

In the example shown in FIG. 2, dryer 46 includes a first dryer 46A for drying one side of web 36 and a second dryer 46B for drying the other side of web 36. Also in the example shown in FIG. 2, the condensation control system for printer 34 includes an air injector 18 upstream from each printhead 48-62.

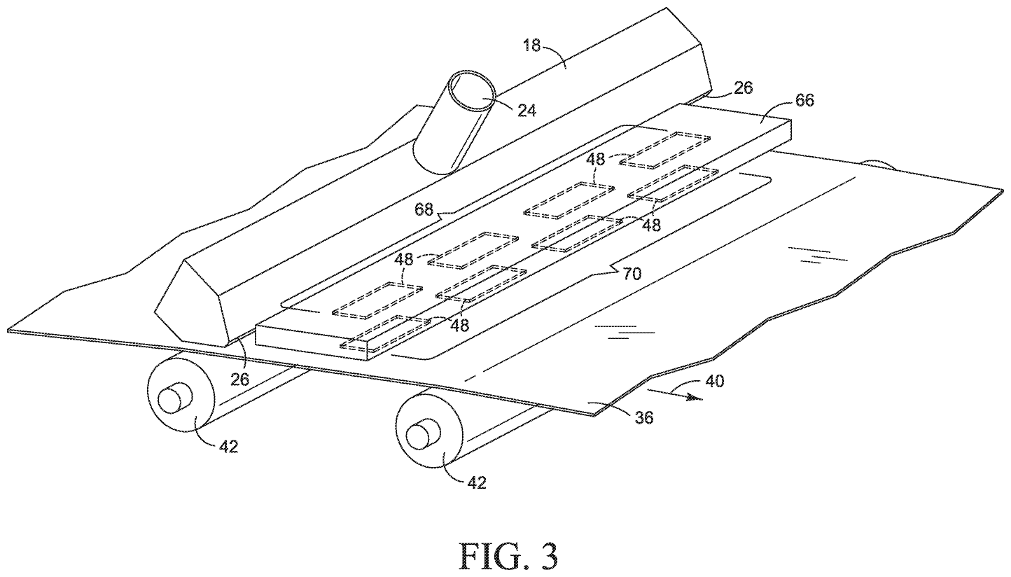

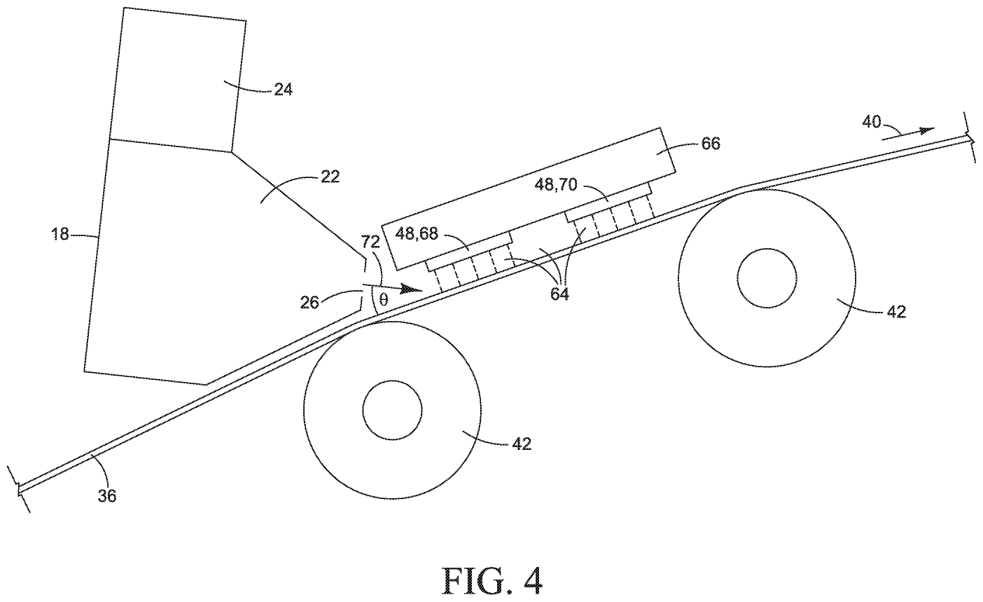

FIGS. 3 and 4 are more detailed views illustrating one of the air injectors 18 from FIG. 2. Referring to FIGS. 3 and 4, print media web 36 moves over rollers 42 past a print bar 66 supporting a group of multiple printheads—black (K) printheads 48 in this example. Printheads 48 in print bar 66 are arranged in two rows 68, 70 across print zone 64 in a staggered configuration in which each printhead in downstream row 70 overlaps one or more printheads in upstream row 68. Air injector 18 in FIGS. 3 and 4 includes a plenum 22, an inlet 24 through which air is introduced into plenum 22, and an outlet 26 from which air is discharged from plenum 22. In this example, discharge outlet 26 is configured as a slit that extends continuously across print zone 64. Air injector 18 is positioned near print bar 66 with outlet 26 upstream from both rows 68, 70 of printheads 48.

Hot dry air is injected into print zone 64 under conditions sufficient to lower the dew point in the print zone to reduce condensation without disturbing ink drops jetted on to print media 36. Arrow 72 in FIG. 4 indicates the flow of air from injector 18 into print zone 64. Testing indicates that, for a high speed thermal inkjet web printer using water based inks with a “pen to paper spacing” of about 1 mm, injecting 40° C. to 55° C. air with a relative humidity of 5% or less into the print zone at 15 m/s to 50 m/s lowers the dew point enough to significantly reduce condensation. Injecting air hotter than 55° C. may be effective to further reduce condensation but risks overheating the printheads and thus degrading print quality.

Testing also indicates that injecting the hot, dry air down toward the print media at about 45° enables reduced condensation without disturbing ink drops jetted on to the moving media. As shown in FIG. 4, injector outlet 26 is oriented down at an angle Θ of 45° with respect print media web 36 passing through print zone 64. Although the discharge angle Θ may be adjusted for the particular printing application, it is expected that a discharge angle Θ of 30° to 60° will enable reduced condensation without disturbing the ink drops in many high speed thermal inkjet web printing applications.

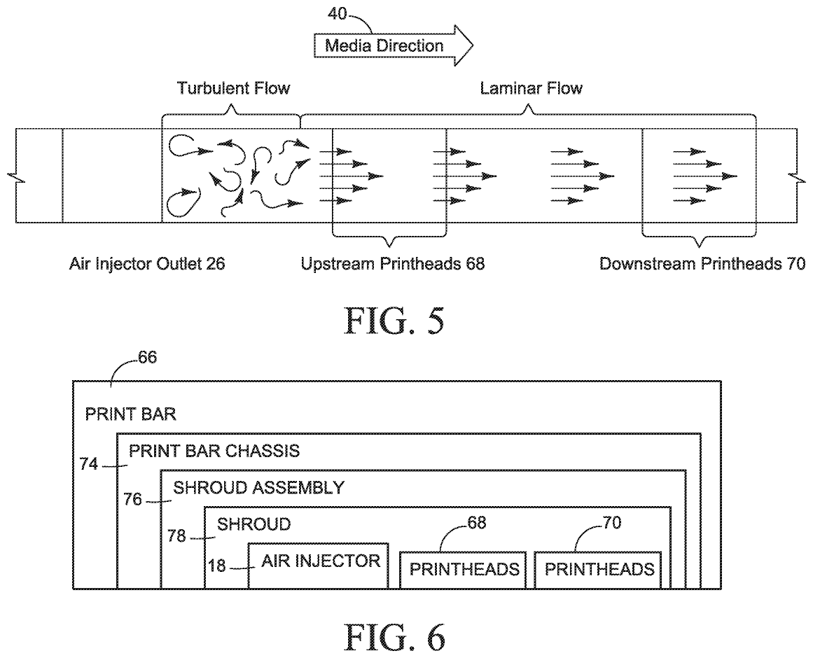

FIG. 5 illustrates flow regimes for injecting hot, dry air into a print zone 64 at a rate of 15 m/s to 50 m/s and at a discharge angle Θ of 45° in FIG. 4. Under these conditions, and referring to FIG. 5, the turbulent flow of hot, dry air at injector outlet 26 becomes laminar within about 3.8 cm. A laminar flow of hot, dry air is less likely to disturb ink drops dispensed from the printheads compared to a turbulent flow of hot, dry air. Therefore, in one example, outlet 26 is located at least 4 cm upstream from the nearest row 68 of printheads 48 to allow for the transition to laminar flow before reaching the printheads. Hot, dry air may be injected at a higher rate where the flow is laminar through the print zone, with a corresponding decrease in dew point, without disturbing the ink drops. However, if outlet 26 is too far from the farthest printheads, more than 30 cm for example, air injector 18 may be ineffective to reduce condensation to the desired levels. Therefore, in one example, outlet 26 is located more than 4 cm from the nearest row 68 of printheads 48 and less than 16 cm from the farthest row 70 of printheads 48.

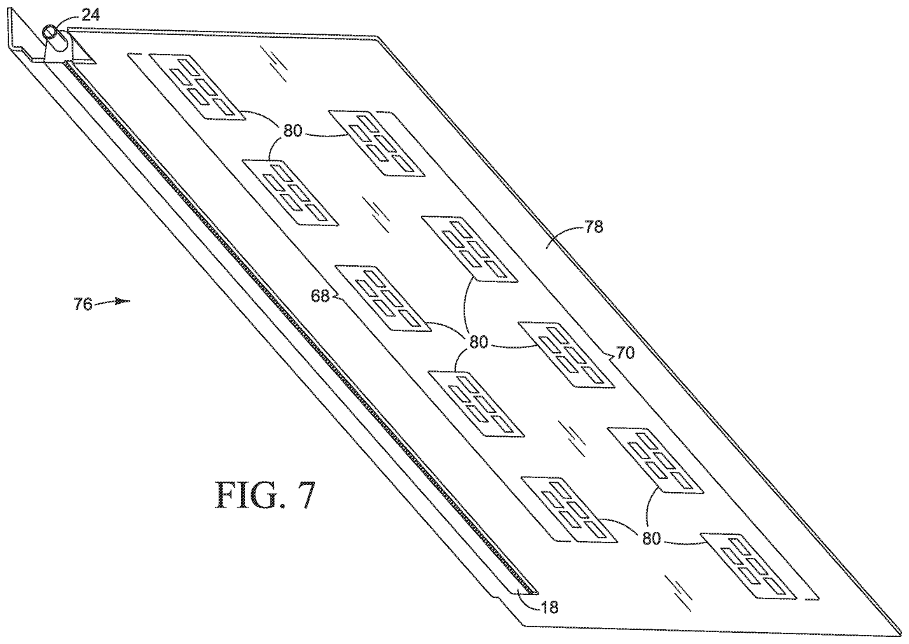

FIG. 6 illustrates one example of a print bar 66 for an inkjet web printer. Referring to FIG. 6, print bar 66 includes an upstream row 68 of printheads and a downstream row 70 of printheads supported by a chassis 74. The printheads in rows 68 and 70 define a print zone spanning substantially the full width of a print media sheet or web passing under print bar 66 during printing. Print bar 66 also includes a shroud assembly 76 supported by chassis 74. Shroud assembly 76 includes a shroud 78 and an air injector 18. Shroud 78 protects otherwise exposed parts of the printheads from contaminants that may be generated during printing. Drops are jetted from the printheads through openings in shroud 78, as described below with reference to FIG. 7.

FIG. 7 illustrates one example of a shroud assembly 76 for a print bar 66 shown in FIG. 6. Referring to FIG. 7, shroud assembly 76 includes a shroud 78 with openings 80 through which ink or other liquid may be jetted from the printheads in rows 68, 70. (The printheads are not part of shroud assembly 76.) Shroud assembly 76 also includes an air injector 18 attached to or integral with shroud 78 upstream from printhead openings 80.

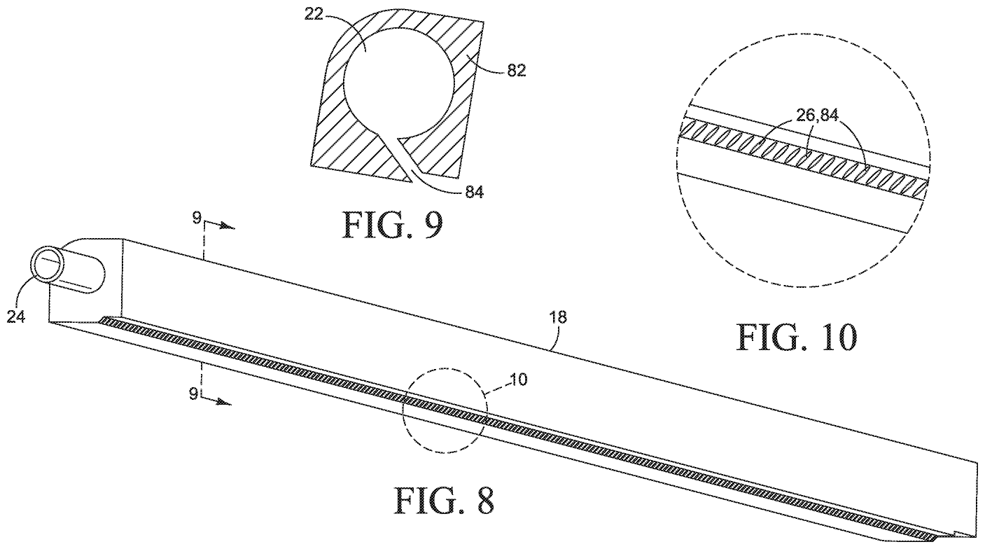

Air injector 18 from FIG. 7 is shown in more detail in FIGS. 8-10. Referring to FIGS. 8-10, injector 18 includes a body 82, a plenum 22 formed as an interior chamber in body 82, an inlet 24 through which air is pumped into plenum 22, and an outlet 26 through which air is discharged from plenum 22. In this example, outlet 26 is configured as a series of conduits 84 through body 82 extending across the full width of the print zone. Conduits 84 are oriented to discharge air down and downstream at the desired angle on to print media moving through the print zone. Plenum 22 and conduits 84 are configured to deliver the desired flow of hot dry air into the print zone. For one example, 1.8 mm diameter circular conduits 84 spaced 5 mm on center will discharge air at about 50 m/s from a plenum 22 pressurized to about 275 kPa. The size and shape of conduits 84 and/or the pressure in plenum 22 may be adjusted to achieve the desired discharge velocity, 15 m/s to 50 m/s for example. In one example, injector 18 is positioned on shroud 78 to discharged air from conduits 84 at least 4 cm upstream from the nearest opening 80 to allow the air to transition to laminar flow before reaching the nearest printheads, when shroud assembly 76 is installed in a print bar with the printheads exposed through openings 80.

FIG. 11 illustrates an example process 100 to control condensation in an inkjet printer, such as might be implemented by a controller 20 executing condensation control instructions 30 in a system 10 shown in FIG. 1. Referring to FIG. 11, process 100 includes injecting hot, dry air into the print zone (block 102). In one example, injecting hot, dry air into the print zone at block 102 includes injecting hot, dry air at an angle of 30° to 60° down and downstream into the print zone at 15 m/s to 50 m/s.

The examples shown in the figures and described above illustrate but do not limit the patent, which is defined in the following Claims.

“A” and “an” used in the claims means one or more.

1. A shroud assembly for a group of printheads that define a print zone in an inkjet printer, the assembly comprising:
a shroud spanning a full width of the print zone and having openings therein through which the printheads are exposed during printing; and
an air injector attached to or integral with the shroud, the air injector spanning a full width of the print zone upstream from all of the openings in the shroud and the air injector configured to discharge air down and downstream with respect to a print media moving through the print zone during printing.

2. The assembly of claim 1, wherein the air injector comprises:
a plenum spanning the full width of the print zone; and
an outlet from the plenum through which air may be discharged from the plenum during printing, the outlet spanning a full width of the print zone and oriented down and downstream with respect to a print media moving through the print zone during printing.

3. The assembly of claim 2, wherein the outlet is oriented down and downstream 30° to 60° with respect to the print media moving through the print zone during printing.

4. The assembly of claim 3, wherein the outlet is located at least 4 cm upstream from a nearest opening in the shroud.

5. The assembly of claim 4, wherein the outlet is configured to discharge 275 kPa plenum air at 15 m/s to 50 m/s.

6. The assembly of claim 5, wherein the outlet comprises multiple holes sized and shaped to discharge 275 kPa plenum air at 15 m/s to 50 m/s.

7. A condensation control system for an inkjet printer with a printhead that defines a print zone, the system comprising:
a heater to heat air;
a dehumidifier to dry air, the heater and the dehumidifier in fluid communication with one another to make hot, dry air;
a plenum upstream from and spanning a full width of the print zone;
an outlet from the plenum through which air may be discharged from the plenum during printing, the outlet spanning a full width of the print zone and oriented down and downstream with respect to a print media moving through the print zone during printing; and
a pump to pressurize the plenum with the hot, dry air.

8. The system of claim 7, comprising a controller configured to:
cause the heater to heat air to 40° C. to 55° C. and the dehumidifier to dry the heated air to 5% or less relative humidity to make the hot, dry air; or
cause the dehumidifier to dry air to 5% or less relative humidity and the heater to heat the dried air to 40° C. to 55° C. to make the hot dry air; and
cause the pump to pressurize the plenum with the hot, dry air.

9. The system of claim 8, wherein the outlet is configured to discharge 275 kPa plenum air at 15 m/s to 50 m/s.

10. The system of claim 9, wherein the outlet comprises multiple holes sized and shaped to discharge 275 kPa plenum air at 15 m/s to 50 m/s.

11. A process to control condensation in an inkjet web printer that includes an inkjet printhead defining a print zone spanning substantially a full width of a moving print media web, the process comprising injecting hot, dry air into the print zone.

12. The process of claim 11, wherein injecting hot, dry air into the print zone comprises injecting hot, dry air 30° to 60° down and downstream toward the moving web at 15 m/s to 50 m/s.

13. The process of claim 11, wherein injecting hot, dry air into the print zone comprises injecting hot, dry air into the print zone from a location at least 4.0 cm upstream from the nearest printhead.
